(19) United States
(12) Patent Application Publication
(10) Pub. No.: US 2025/0217409 A1
(43) Pub. Date: Jul. 3, 2025

(54) IMAGE SEARCH METHOD, INTELLIGENT AGENT, ELECTRONIC DEVICE, AND STORAGE MEDIUM

(71) Applicant: Beijing Baidu Netcom Science Technology Co., Ltd., Beijing (CN)

(72) Inventors: Jingbo ZHOU, Beijing (CN); Pengfei LUO, Beijing (CN); Yuan XIA, Beijing (CN); Tong XU, Beijing (CN)

(21) Appl. No.: 19/084,442

(22) Filed: Mar. 19, 2025

(30) Foreign Application Priority Data
Dec. 3, 2024 (CN) 202411764757.8

(51) Int. Cl. G06F 16/535; G06F 40/30; G06V 10/70

(52) U.S. Cl. CPC G06F 16/535; G06F 40/30; G06V 10/70

(57) ABSTRACT

An image search method, an intelligent agent, an electronic device, and a storage medium are provided, which relate to a field of artificial intelligence technology. The method includes: acquiring at least one first candidate image matched with an input text information; performing a semantic analysis on the input text information by using a first large model to generate at least one question-answer pair which includes a question information and a first answer information; performing an image-text analysis on the question information and the at least one first candidate image by using a second large model to generate a second answer information for answering each question information; and determining at least one target image matched with the image search requirement from the at least one first candidate image according to a comparison result between the at least one first answer information and the at least one second answer information.

### CROSS-REFERENCE TO RELATED APPLICATIONS

This application is claims priority to Chinese Application No. 2024117647578 filed on Dec. 3, 2024, which is incorporated herein by reference in its entirety.

### TECHNICAL FIELD

The present disclosure relates to a field of artificial intelligence technology, in particular to fields of computer vision, deep learning, large model, image search and other technologies, and may be applied to scenarios such as AIGC (Artificial Intelligence Generated Content). Specifically, the present disclosure relates to an image search method and apparatus, an intelligent agent, an electronic device, and a storage medium.

### BACKGROUND

With a continuous development of artificial intelligence technology, large model technology has been applied in various fields. For example, it is possible to perform an image search using large models.

However, at present, there may be a content deviation such as semantic inconsistency in details between an input information and an image obtained through image search based on large models.

### SUMMARY

The present disclosure provides an image search method and apparatus, an intelligent agent, an electronic device, and a storage medium

According to an aspect of the present disclosure, an image search method is provided, including: acquiring at least one first candidate image matched with an input text information, where the input text information represents an image search requirement; performing a semantic analysis on the input text information by using a first large model to generate at least one question-answer pair, where the question-answer pair includes a question information extracted from the input text information and a first answer information extracted from the input text information; performing an image-text analysis on the at least one question information and the at least one first candidate image by using a second large model to generate a second answer information for answering each question information; and determining at least one target image matched with the image search requirement from the at least one first candidate image according to a comparison result between the at least one first answer information and the at least one second answer information.

According to another aspect of the present disclosure, an image search apparatus is provided, including: an acquisition module configured to acquire at least one first candidate image matched with an input text information entered by a user, where the input text information represents an image search requirement of the user; a semantic analysis module configured to perform a semantic analysis on the input text information by using a first large model to generate at least one question-answer pair, where the question-answer pair includes a question information extracted from the input text information and a first answer information extracted from the input text information; an image-text analysis module configured to perform an image-text analysis on the at least one question information and the at least one first candidate image by using a second large model to generate a second answer information for answering each question information; and a determination module configured to determine at least one target image matched with the image search requirement from the at least one first candidate image according to a comparison result between the at least one first answer information and the at least one second answer information.

According to another aspect of the present disclosure, an intelligent agent of artificial intelligence is provided, configured to perform the method provided in embodiments of the present disclosure.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to implement the method described above.

According to another aspect of the present disclosure, a non-transitory computer-readable storage medium having computer instructions therein is provided, and the computer instructions are configured to cause a computer to implement the method described above.

According to another aspect of the present disclosure, a computer program product containing a computer program is provided, the computer program when executed by a processor is configured to cause the processor to implement the method described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure. In the accompanying drawings:

FIG. 1 schematically shows an exemplary system architecture to which an image search method and apparatus may be applied according to embodiments of the present disclosure;

FIG. 2 schematically shows a flowchart of an image search method according to embodiments of the present disclosure;

FIG. 3 schematically shows a scenario diagram of an image search method according to an embodiment of the present disclosure;

FIG. 4 schematically shows a scenario diagram of generating a question-answer pair according to an embodiment of the present disclosure;

FIG. 5 schematically shows a scenario diagram of acquiring a first prompt information according to an embodiment of the present disclosure;

FIG. 6 schematically shows a scenario diagram of determining a target image according to an embodiment of the present disclosure;

FIG. 7A schematically shows a scenario diagram of determining a target image using a third large model according to an embodiment of the present disclosure;

FIG. 7B schematically shows a scenario diagram of determining a target image using a third large model according to another embodiment of the present disclosure;

FIG. 8 schematically shows a scenario diagram of the third large model performing an image-text analysis task and an interpretation task according to an embodiment of the present disclosure;

FIG. 9 schematically shows a scenario diagram of determining a target image according to a specific embodiment of the present disclosure;

FIG. 10 schematically shows a block diagram of an image search apparatus according to a specific embodiment of the present disclosure;

FIG. 11 schematically shows a structural block diagram of an intelligent agent of artificial intelligence according to embodiments of the present disclosure; and

FIG. 12 schematically shows a block diagram of an electronic device 1200 suitable for implementing the image search method according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

Some image search solutions may be used to search and return an image based on a user input text information, but the returned image may not fully or partially meet a search intent. For example, the returned image may not fully or partially meet a user requirement at a semantic level.

For example, a content-based image search may match images by extracting low-level features such as color histograms or edge features of images, and a label-based image search may use metadata or manually annotated labels in images for search. These methods only process a surface feature of an image but fails to understand or capture a deep semantic feature. These methods are only suitable for simple image matching tasks, but have a low search accuracy for complex language descriptions or combined search tasks. In addition, a vision-language model-based image search may map data in visual and linguistic modalities to a shared vector space to achieve a basic semantic alignment, such as calculating a similarity between visual modality vectors and linguistic modality vectors. However, a semantic alignment in the vector space is coarse so that precise semantic consistency cannot be ensured. For example, subtle image details (such as color, shape, position) or complex semantic relationships (such as interactions between objects) may not be accurately captured and matched.

In summary, there may be a semantic deviation in details and complex semantic relationships between an input information and an image obtained by these image search solutions, resulting in a low accuracy of image search.

In order to at least partially solve the above technical problems, embodiments of the present disclosure provide an image search method, including: acquiring at least one first candidate image matched with an input text information, where the input text information represents an image search requirement; performing a semantic analysis on the input text information by using a first large model to generate at least one question-answer pair, where the question-answer pair includes a question information extracted from the input text information and a first answer information extracted from the input text information; performing an image-text analysis on the at least one question information and the at least one first candidate image by using a second large model to generate a second answer information for answering each question information; and determining at least one target image matched with the image search requirement from the at least one first candidate image according to a comparison result between the at least one first answer information and the at least one second answer information. Therefore, embodiments of the present disclosure may solve at least the problem of semantic deviation between the output image and the input, thereby achieving the technical effect of improving the accuracy of image search.

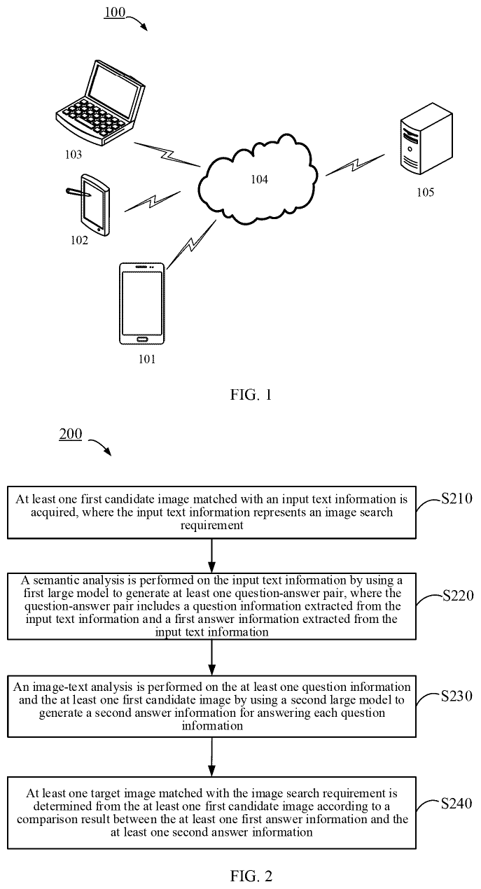

FIG. 1 schematically shows an exemplary system architecture to which an image search method and apparatus may be applied according to embodiments of the present disclosure.

It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios. For example, in other embodiments, the exemplary system architecture to which the image search method and apparatus may be applied may include a terminal device, but the terminal device may implement the method and apparatus provided in embodiments of the present disclosure without interacting with a server.

As shown in FIG. 1, the system architecture 100 according to such embodiments may include a first terminal device 101, a second terminal device 102, a third terminal device 103, a network 104, and a server 105. The network 104 is a medium for providing a communication link between the terminal device 101, the terminal device 102, the terminal device 103 and the server 105. The network 104 may include various connection types, such as wired and/or wireless communication links, etc.

The first terminal device 101, the second terminal device 102 and the third terminal device 103 may be used by a user to interact with the server 105 through the network 104 to receive or send messages, etc. The first terminal device 101, the second terminal device 102 and the third terminal device 103 may be installed with various communication client applications, such as knowledge reading applications, web browser applications, search applications, instant messaging tools, email clients and/or social platform software, etc. (for example only).

The first terminal device 101, the second terminal device 102 and the third terminal device 103 may be various electronic devices having display screens and supporting web browsing, including but not limited to smart phones, tablet computers, laptop computers, and desktop computers, etc.

The server 105 may be a server providing various services, such as a background management server (for example only) that provides a support for content browsed by the user using the first terminal device 101, the second terminal device 102 and the third terminal device 103. The background management server may analyze and process received data such as a user request, and feed back a processing result (such as a web page, information or data acquired or generated according to the user request) to the terminal devices.

The server 105 may be a cloud server, also known as a cloud computing server or a cloud host, which is a host product in a cloud computing service system to solve shortcomings of difficult management and weak service scalability existing in a conventional physical host and VPS (Virtual Private Server) service. The server 105 may also be a server of a distributed system or a server combined with a block-chain.

It should be noted that the image search method provided in embodiments of the present disclosure may generally be performed by the terminal device 101, the terminal device 102 and the terminal device 103. Accordingly, the image search apparatus provided in embodiments of the present disclosure may also be arranged in the terminal device 101, the terminal device 102 and the terminal device 103.

Alternatively, the image search method provided in embodiments of the present disclosure may generally be performed by the server 105. Accordingly, the image search apparatus provided in embodiments of the present disclosure may generally be arranged in the server 105. The image search method provided in embodiments of the present disclosure may also be performed by a server or server cluster different from the server 105 and capable of communicating with the terminal device 101, the terminal device 102, the terminal device 103 and/or the server 105. Accordingly, the image search apparatus provided in embodiments of the present disclosure may also be arranged in a server or server cluster different from the server 105 and capable of communicating with the terminal device 101, the terminal device 102, the terminal device 103 and/or the server 105.

For example, the user is allowed to input an input text information for image search through the first terminal device 101, the second terminal device 102 and the third terminal device 103. The first terminal device 101, the second terminal device 102 and the third terminal device 103 may be used to: acquire at least one first candidate image matched with the input text information, where the input text information represents an image search requirement; perform a semantic analysis on the input text information by using a first large model to generate at least one question-answer pair, where the question-answer pair includes a question information extracted from the input text information and a first answer information extracted from the input text information; perform an image-text analysis on the at least one question information and the at least one first candidate image by using a second large model to generate a second answer information for answering each question information; and determine at least one target image matched with the image search requirement from the at least one first candidate image according to a comparison result between the at least one first answer information and the at least one second answer information.

Alternatively, it is possible to send a document to the server 105 through the first terminal device 101, the second terminal device 102 and the third terminal device 103 to acquire an input text information for image search, perform the above-mentioned image search method using the server 10 to determine at least one target image, and return the at least one target image to the first terminal device 101, the second terminal device 102 and the third terminal device 103.

It should be understood that the number of terminal devices, networks and servers in FIG. 1 is merely illustrative. According to implementation needs, any number of terminal devices, networks and servers may be provided.

In technical solutions of the present disclosure, a collection, a storage, a use, a processing, a transmission, a provision, a disclosure, an application and other processing of user personal information involved comply with provisions of relevant laws and regulations, take necessary security measures, and do not violate public order and good customs.

In the technical solutions of the present disclosure, the acquisition or collection of user personal information has been authorized or allowed by users.

FIG. 2 schematically shows a flowchart of an image search method according to embodiments of the present disclosure.

As shown in FIG. 2, a method 200 includes operation S210 to operation S240.

In operation S210, at least one first candidate image matched with an input text information is acquired, where the input text information represents an image search requirement.

The input text information includes a text information obtained by at least one input operation of the user, such as a combined text information obtained after clarifying the image search requirement based on at least one round of dialogue. Alternatively, the input text information may be a text information obtained by processing an input multimodal information, for example, by converting an information in visual modality or an information in audio modality into an input text information in linguistic modality.

In an application scenario, the user is allowed to engage in dialogues with a digital avatar/virtual avatar through 2D perspectives such as display interface or through 3D perspectives such as virtual augmented reality to input multimodal information, so as to directly acquire a text information in linguistic modality or convert information in other modalities into a text information in linguistic modality, thereby obtaining the input text information.

The image search requirement, also known as an image search intent, includes various requirements related to an image search task, such as searching for images similar to a particular image, searching for a particular type of image, or searching for images of product XX.

The first candidate image may be an image obtained by a pre-selection operation and matched with the input text information. For example, the method of acquiring at least one first candidate image matched with the input text information may include: selecting an image of the same type, the same size or the same source as the input text information from a plurality of images to obtain the first candidate image. Alternatively, the first candidate image may be an image obtained by a rough selection at a semantic level. For example, it is possible to semantically align the input text information with a plurality of images in the vector space, select an image similar to the input text information, and determine the similar image as the first candidate image.

In operation S220, a semantic analysis is performed on the input text information by using a first large model to generate at least one question-answer pair, where the question-answer pair includes a question information extracted from the input text information and a first answer information extracted from the input text information.

The first large model may be a pre-trained single-modal large model, such as a large language model (LLM) in linguistic modality; or may be a pre-trained large multimodal model (LMM) capable of processing linguistic modality.

The first large model may perform a semantic analysis on the input text information which acts as a model input, and output at least one question-answer pair. Specifically, the semantic analysis may be a splitting/extraction of information from the input text information in semantic dimensions, and paired question information and first answer information may be output. Each question-answer pair output by the first large model represents a result of a local semantic analysis of the input text information.

In an exemplary embodiment, the question information in the question-answer pair contains less information than the input text information, such as fewer objects or fewer attributes of objects than the input text information.

For example, if the input text information is “Person 1 is eating at a dining table”, the question-answer pairs output by the first large model may include: “Is Person 1 eating? Yes”, “Is the meal on the dining table? Yes”, and “Is Person 1 at the dining table? Yes”. The question information includes “Is Person 1 eating?”, “Is the meal on the dining table?”, and “Is Person 1 at the dining table?”. The first answer information includes “Yes”, “Yes”, and “Yes”.

In operation S230, an image-text analysis is performed on the at least one question information and the at least one first candidate image by using a second large model to generate a second answer information for answering each question information.

The second large model is a large multimodal model LMM capable of processing visual modality and linguistic modality. The second large model is a pre-trained large multimodal model. An input of the second large model is a multimodal information, such as the at least one question information and the at least one candidate image.

The second large model may perform an image-text analysis on the at least one question information and the at least one candidate image according to an image-text analysis task. The image-text analysis task may include understanding an information in the first candidate image and answering the question information.

In an exemplary embodiment, the second large model may perform the image-text analysis task according to a single question information and a single first candidate image, and generate a second answer information for answering the question information. Alternatively, the second large model may perform the image-text analysis task according to a plurality of question information and a single first candidate image, and generate a second answer information for answering each question information after understanding content of the first candidate image. For example, it is possible to input a plurality of question information and a single first candidate image, in the form of an array, to the second large model.

For example, if question information 1 is “Is Person 1 at the dining table?”, the second large model may generate a second answer information “No” for answering the question information 1 after understanding the first candidate image 1, and generate a second answer information “Yes” for answering the question information 1 after understanding the first candidate image 2.

In operation S240, at least one target image matched with the image search requirement is determined from the at least one first candidate image according to a comparison result between the at least one first answer information and the at least one second answer information.

The number of first answer information is the same as the number of second answer information. The first answer information and the second answer information are two answer information respectively generated by the first large model and the second large model for the same question information. Therefore, it is possible to compare the first answer information and the second answer information for the same question information to select at least one target image matched with the image search requirement from the at least one first candidate image.

For example, for the at least one question information, the comparison results between the first answer information and the second answer information for the question information may be synthesized to select at least one target image. The comparison result may be a similarity between the first answer information and the second answer information. For example, it is possible to select at least one target image by synthesizing the similarities between the first answer information and the second answer information for the question information. For another example, it is possible to perform a weighted summation on the similarities between the first answer information and the second answer information for the question information, and select the target image according to a summation result. Alternatively, it is possible to determine whether the first answer information and the second answer information for each question information are identical or different, and count the number of identical or different to select at least one target image. In addition, the number of target image may be determined based on a predetermined threshold or selection quantity.

In embodiments of the present disclosure, since the first large model splits the input text information into at least one question-answer pair, the question information in the question-answer pair has a finer semantic granularity than the input text information, and the first answer information and the second answer information are answers to the question information with finer granularity. Therefore, according to the comparison result between the first answer information and the second answer information, the selection may be performed from a perspective of local semantics with finer granularity, and a target image with a less local semantic deviation may be selected from the first candidate images, thereby improving the accuracy of image search. In addition, since the comparison results between the first answer information and the second answer information for the at least one question information are synthesized, embodiments of the present disclosure may ensure that the target image has less overall semantic deviation, thereby improving the accuracy of image search.

In addition, before the image-text analysis is performed using the second large model, a preliminary selection is performed to obtain the first candidate image matched with the input text information, which ensures the accuracy of image search while reducing the data processing load of the second large model, thereby improving a speed of image search.

According to embodiments of the present disclosure, for operation S220, performing a semantic analysis on the input text information by using the first large model to generate at least one question-answer pair includes: acquiring a first prompt information, where the first prompt information is used to prompt the first large model to perform a semantic analysis task and a form conversion task; performing the semantic analysis task based on the first prompt information and the input text information by using the first large model, so as to extract at least one input text sub-information from the input text information; and performing the form conversion task on each input text sub-information based on the first prompt information by using the first large model, so as to convert the input text sub-information into the question-answer pair.

The first large model is used to sequentially perform the semantic analysis task and the form conversion task. For example, the first large model may be prompted to sequentially perform the above two tasks through a pre-built first prompt information. When the first large model is used, the first prompt information may be directly acquired.

The first prompt information reserves a position for filling in the input text information. For example, the first prompt information contains a placeholder [INSTRUCTION]. After the first prompt information is acquired, the current input text information may be filled into the placeholder [[INSTRUCTION]] to obtain a new input.

The semantic analysis task is performed by the first large model to understand and analyze the semantics of the input text information and extract at least one input text sub-information from the input text information according to the semantics. Each input text sub-information contains partial semantics of the input text information.

The input text sub-information may be in the form of declarative sentence. The form of the input text sub-information may be specified in the first prompt information. For example, an information in the first prompt information used to prompt the first large model to perform the semantic analysis task may be “decompose an input text instruction into multiple verifiable declarative sentences”, where the “text instruction” is the input text information, and the “declarative sentence” is the form of the input sub-information.

In an exemplary embodiment, the input text sub-information may be directly decomposed from the input text information, or may be obtained by extracting and recombining information from the input text information.

The form conversion task is used to convert the input text sub-information obtained from the semantic analysis task into a predetermined form, such as a question-answer pair in the form of question+answer.

In an exemplary embodiment, the form of the first answer information may be defined through the first prompt information to be identical or similar to the form of the second answer information, so as to facilitate the subsequent comparison between the first answer information and the second answer information.

For ease of understanding, an example of the first prompt information will be given below. For example, the first prompt information may be: “#Task description: The semantic analysis task involves decomposing a text instruction into multiple simple and verifiable propositions, each with a unique answer of ‘Yes’ or ‘No’. According to the provided instruction, it is required to decompose the instruction into several atomic propositions and corresponding answers, following the two steps below. ##Step 1: Convert to declarative sentences: Decompose the input text instruction into multiple verifiable declarative sentences. ##Step 2: Convert to question form: Convert each declarative sentence into a question form and provide a correct answer according to the given instruction. The text instruction will be provided to complete the task: input text information”. Step 1 and Step 2 correspond to the semantic analysis task and the form conversion task, respectively.

In embodiments of the present disclosure, through the first prompt information, the first large model may sequentially perform the semantic analysis task and the form conversion task to obtain at least one question-answer pair. The hierarchical and sequential task execution method allows the first large model to better understand a complex semantic relationship and detailed information in the input text information, thereby improving the accuracy of local semantic extraction of the question information in the question-answer pair. In addition, converting the input text sub-information into the question-answer pair form may facilitate the subsequent image-text analysis of the question information and the comparison between the second answer information and the first answer information.

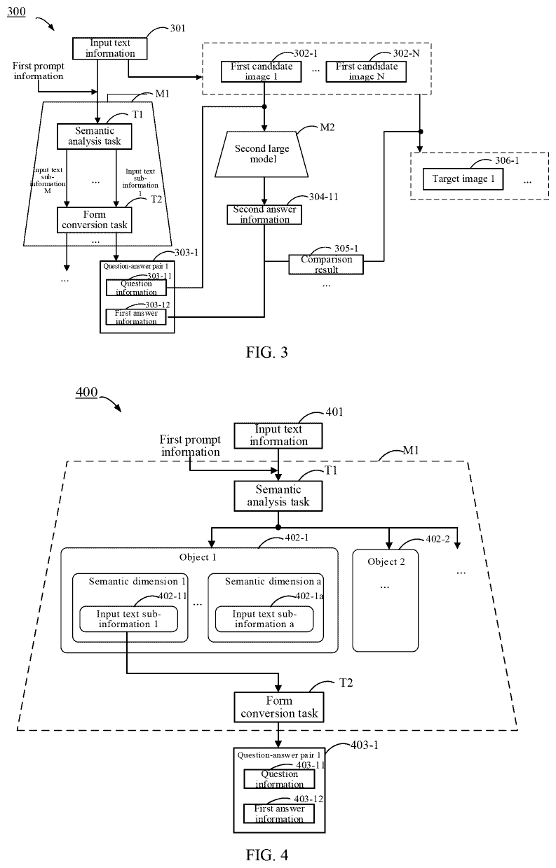

FIG. 3 schematically shows a scenario diagram of the image search method according to an embodiment of the present disclosure. As shown in FIG. 3, embodiment 300 is used to search for at least one target image, such as target image 1 306-1 . . . , matched with an image search requirement represented by an input text information 301.

In such embodiment, the input text information 301 and the first prompt information are input into a first large model M1. The first large model M1 may perform a semantic analysis task T1 according to the first prompt information and the input text information 301 to obtain at least one input text sub-information, such as input text sub-information 1 . . . input text sub-information M. Then, the first large model M1 may perform a form conversion task T2 on each input text sub-information. For example, the first large model M1 performs the form conversion task T2 on the input text sub-information 1 to obtain a question-answer pair 1 303-1, which includes a question information 303-11 and a first answer information 303-12.

In addition, for the input text information 301, it is possible to select at least one first candidate image, such as first candidate image 1 302-1 . . . first candidate image N 302-N, matched with the input text information 301.

After the question information 303-11 is output by the first large model M1, the question information 303-11 and the first candidate image 1 302-1 may be input into a second large model M2. After understanding the first candidate image 1 302-1, the second large model M2 may generate a second answer information 304-11 for answering the question information 303-11, and compare the first answer information 303-12 and the second answer information 304-11 for the question information 303-11 to obtain a comparison result 305-1. Similarly, the comparison result between other question information and other first candidate image may be obtained as above, which will not be repeated here.

After the comparison result between the at least one first answer information and the at least one second answer information is obtained, it is possible to select at least one target image from the at least one first candidate image according to the comparison result. For example, according to the comparison results 305-1 . . . , it may be determined whether to select the first candidate image 301-1 as the target image from the first candidate image 1 302-1 . . . the first candidate image N 302-N.

According to embodiments of the present disclosure, performing the semantic analysis task based on the first prompt information and the input text information by using the first large model to extract at least one input text sub-information from the input text information includes: performing the semantic analysis task based on the first prompt information and the input text information by using the first large model, so as to extract at least one input text sub-information from the input text information based on a plurality of semantic dimensions, where the semantic dimension includes at least one of a color, a shape, or a background.

The input text information may contain at least one object, such as person, animal, plant, or article. In some embodiments, the first large model may extract at least one input text sub-information from the input text information based on the perspective of multiple objects, such as understanding a complex semantic relationship between objects. To better understand local semantics from a plurality of semantic dimensions, the first prompt information may be added with constraints of semantic dimensions, so that the first large model may extract at least one input text sub-information from a plurality of semantic dimensions.

For example, the first prompt information may contain a prompt for semantic dimensions, such as “decompose the input text instruction into multiple verifiable declarative sentences, where the multiple declarative sentences cover at least one of the following semantic dimensions: color, shape, and background”.

Alternatively, the first prompt information may provide a semantic analysis example to help the first large model understand how to extract at least one input text sub-information from the input text information based on a plurality of semantic dimensions.

For example, the first prompt information A may be: “Decompose the input text instruction into multiple verifiable declarative sentences. An example for reference is as follows: For the text instruction “A woman wearing a black shirt is cooking on the stove, with a black dog sitting next to her”, the decomposed declarative sentences include “There is a woman wearing a black shirt in the image. The woman in the image is cooking. There is a black dog in the image. The black dog in the image is next to the woman”. Please query according to ##: Execute the text instruction: [[INSTRUCTION]]”. It may be understood that in the example, the input text sub-information contains objects “woman” and “dog”, the color includes “black shirt” and “black dog”, and the background includes “the black dog is next to the woman”.

In embodiments of the present disclosure, since the at least one input text sub-information is based on a plurality of semantic dimensions, the question information converted from the input text sub-information has richer semantic dimensions and may focus on the complex semantic relationship and detailed information, thereby improving the accuracy of the question information and helping to improve the accuracy of subsequent image search.

FIG. 4 schematically shows a scenario diagram of generating a question-answer pair according to an embodiment of the present disclosure. As shown in FIG. 4, in embodiment 400, the first large model M1 performs a semantic analysis task T1 according to an input text information 401 and the first prompt information to obtain a plurality of input text sub-information for a plurality of objects. For example, object 1 402-1 contains input text sub-information 1 402-11 under semantic dimension 1 . . . input text sub-information a 402-1a under semantic dimension a; and object 2 402-2 contains input text sub-information . . . .

For each semantic dimension, the first large model M1 may perform a form conversion task T2 to output a question-answer pair. For example, for the input text sub-information 1 402-11, a question-answer pair 1 403-1 may be obtained after the form conversion task T2 is performed, where the question-answer pair 1 403-1 includes a question information 403-11 and a first answer information 403-12.

According to embodiments of the present disclosure, acquiring the first prompt information includes: combining a semantic splitting example and a form conversion example to obtain the first prompt information.

The semantic splitting example includes: at least one input text sub-information obtained by performing a semantic splitting task based on a predetermined input text information, or at least one input text sub-information under a plurality of semantic dimensions.

The form conversion example includes: a question-answer pair obtained by performing a form conversion task based on a predetermined input text sub-information.

The semantic splitting example and the form conversion example are obtained by sequentially performing the semantic splitting task and the form conversion task based on the same predetermined input text information.

Combining the semantic splitting example and the form conversion example to obtain the first prompt information may include: filling the semantic splitting example and the form conversion example into a prompt information template to obtain the first prompt information. In addition, the prompt information template may contain a description information of the semantic splitting task and the form conversion task.

For example, still taking the first prompt information A as an example, a semantic analysis example is given in the first prompt information A and is used as step 1. The first prompt information may further contain a form conversion example as follows: “Step 2. Based on step 1, the questions and answers are as follows: 1. Question: Is there a woman wearing a black shirt? Answer: Yes. 2. Question: Is there a woman cooking? Answer: Yes. 3. Question: Is there a black dog? Answer: Yes. 4. Question: Is the black dog next to the woman? Answer: Yes”.

In embodiments of the present disclosure, by combining the semantic splitting example and the form conversion example to obtain the first prompt information, the first large model may better understand and perform the semantic splitting task and the form conversion task based on the first prompt information, thereby obtaining more accurate question-answer pairs.

According to embodiments of the present disclosure, acquiring the first prompt information includes: determining, according to a scene type of the input text information, a semantic splitting example matched with the scene type and a form conversion example matched with the scene type; and combining the semantic splitting example matched with the scene type and the form conversion example matched with the scene type to obtain the first prompt information.

A plurality of input text information may correspond to a plurality of semantic splitting examples and a plurality of form conversion examples. For example, input text information of various scene types corresponds to various semantic splitting examples and various form conversion examples. The scene type may be understood as a scene of the input text information, such as life scene, shopping scene, translation scene, etc.

Various scene types may be different in terms of commonly used statements, description habits, grammar, etc. Therefore, when acquiring the first prompt information, it is possible to first determine the scene type of the input text information, and then determine the semantic splitting example matched with the scene type and the form conversion example matched with the scene type. For example, it is possible to determine the scene type of the input text information by using a large classification model, and then combine predetermined semantic splitting example and form conversion example under the scene type to obtain the first prompt information.

A scene type may include a plurality of semantic splitting examples and a plurality of form conversion examples. Therefore, after the scene type of the input text information is determined, it is possible to randomly determine, from the scene type, one or more groups of semantic splitting examples and form conversion examples for the same input text information, which are then combined into the first prompt information.

In embodiments of the present disclosure, by combining the semantic splitting example matched with the scene type of the input text information and the form conversion example matched with the scene type of the input text information to obtain the first prompt information, it is possible to provide an example closer to the scene type of the input text information, so that the first large model may better understand and perform the semantic splitting task and the form conversion task, thereby obtaining more accurate question-answer pairs.

According to embodiments of the present disclosure, acquiring the first prompt information includes: determining at least one semantic splitting example and at least one form conversion example according to a text complexity of the input text information; and combining the at least one semantic splitting example and the at least one form conversion example to obtain the first prompt information.

The text complexity may be determined by a length of the input text information or the number of objects contained in the input text information. For example, the complexity of “a woman wearing a black shirt is cooking on the stove, with a black dog sitting next to her” is higher than that of “a woman wearing a black shirt is cooking on the stove”.

The higher the text complexity, the more complex the semantic relationship and the more the detailed information in the input text information. Therefore, based on the text complexity, the number of semantic splitting examples and form conversion examples may be increased, then one or more semantic splitting examples and one or more form conversion examples may be determined, and the one or more semantic splitting examples and the one or more form conversion examples may be combined to obtain the first prompt information. For example, when the text complexity is within a particular complexity range, the number of semantic splitting examples and the number of form conversion examples corresponding to the complexity range may be determined according to a mapping table of complexity range.

In embodiments of the present disclosure, by determining the number of semantic splitting examples and form conversion examples according to the text complexity of the input text information, the first large model may understand more complex input text information and perform the semantic splitting task and the form conversion task, thereby obtaining more accurate question-answer pairs.

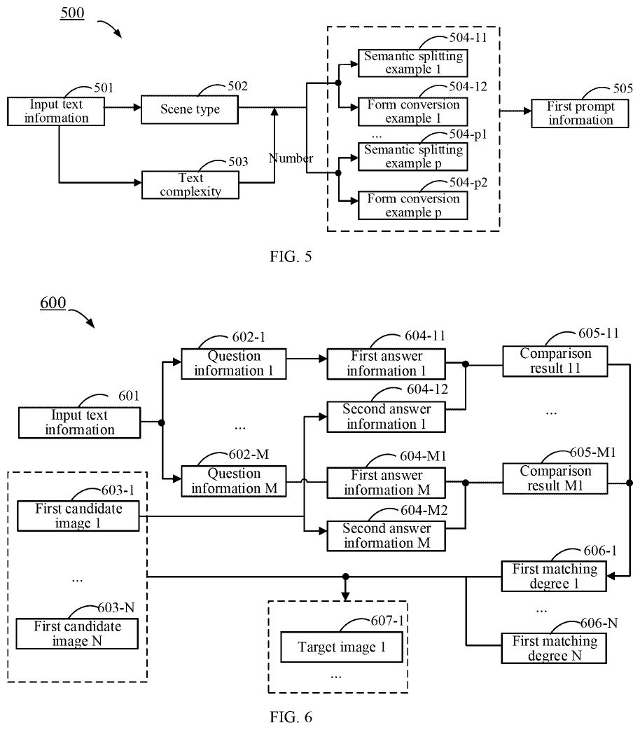

FIG. 5 schematically shows a scenario diagram of acquiring the first prompt information according to an embodiment of the present disclosure. As shown in FIG. 5, embodiment 500 is implemented to generate the first prompt information according to the scene type and the text complexity.

As shown in FIG. 5, according to an input text information 501, a scene type 502 and a text complexity 503 of the input text information 501 may be determined. Then, the number of semantic splitting examples and form conversion examples may be determined based on the text complexity 503, and the same number of at least one semantic splitting example and at least one form conversion example, such as semantic splitting example 1 504-11 and form conversion example 1 504-12 . . . semantic splitting example p 504-p1 and form conversion example p 504-p2, may be determined from a plurality of semantic splitting examples and a plurality of form conversion examples under the scene type 502. The above examples may be combined to obtain a first prompt information 505.

According to embodiments of the present disclosure, for operation S240, determining at least one target image matched with the image search requirement from the at least one first candidate image according to the comparison result between the at least one first answer information and the at least one second answer information includes: determining, for each first candidate image, a comparison result between the first answer information and the second answer information for answering a same question information; determining a first matching degree between each first candidate image and the input text information according to the comparison result; and selecting the at least one target image matched with the image search requirement from the at least one first candidate image according to the first matching degree.

For example, it is possible to calculate a similarity between the first answer information and the second answer information for answering the same question information, and determine a comparison result according to the similarity. For example, the comparison result may be determined as identical or different. If the similarity is greater than a similarity threshold, the comparison result is determined as identical; otherwise, the comparison result is determined as different.

In an embodiment, for each first candidate image, the first matching degree between the first candidate image and the input text information may be determined according to the number of question information with the comparison result of identical. For example, the number may be directly used as the first matching degree. In another embodiment, the similarity between the first answer information and the second answer information for answering the same question information may be directly used as the comparison result, and an average value of the comparison results of the plurality of question information may be used as the first matching degree.

In another embodiment, since an object that servers as a subject in the input text information is typically important, a higher weight may be assigned to the question information containing the subject. Then, the comparison result of identical is assigned a value of 1, and the comparison result of different is assigned a value of 0. The first matching degree between each first candidate image and the input text information may be determined by a weighted summation method, so as to increase a weight of the subject in the image search process.

After the first matching degree is determined, it is possible to select at least one target image matched with the image search requirement from the at least one first candidate image directly according to the first matching degree. For example, the at least one first candidate image may be sorted in descending order according to the first matching degree, and the top predetermined number of first candidate image may be determined as the target image.

In embodiments of the present disclosure, since each question information represents local semantics of the input text information, the first matching degree may be determined by synthesizing the number of question information with the comparison result of identical, which allows for selecting based on the matching degree of local semantics and also reflects the matching degree of overall semantics through the number. Therefore, using the first matching degree for selection may improve the accuracy of image search.

FIG. 6 schematically shows a scenario diagram of determining the target image according to an embodiment of the present disclosure. As shown in FIG. 6, in embodiment 600, at least one question-answer pair is generated after a semantic analysis is performed on an input text information 601 by using the first large model. The at least one question-answer pair corresponds to at least one question information, such as question information 1 602-1 . . . question information M 602-M. The at least one question-answer pair further corresponds to at least one first answer information, such as first answer information 1 604-11 . . . first answer information M 604-M1.

At least one first candidate image matched with the input text information 601 may include: first candidate image 1 603-1 . . . first candidate image N 603-N. For the first candidate image 1 603-1, at least one second answer information, such as second answer information 1 604-12 . . . second answer information M 604-M2, may be obtained after an image-text analysis is performed on the first candidate image 1 603-1 and the at least one question information by using the second large model.

By synthesizing a comparison result 11 605-11 between the first answer information 1 604-11 and the second answer information 1 604-12, . . . , and a comparison result M1 605-M1 between the first answer information M 604-M1 and the second answer information M 604-M2, a first matching degree 1 606-1 for the first candidate image 1 603-1 may be obtained. Similarly, a first matching degree N 606-N for the first candidate image N may be obtained based on the above method. At least one target image such as target image 1 607-1 . . . may be selected from the first candidate image 1 603-1 . . . first candidate image N 603-N according to the first matching degree 1 606-1 . . . first matching degree N 606-N.

According to embodiments of the present disclosure, for operation S240, the method further includes: performing an image-text analysis on the input text information and the at least one first candidate image by using a third large model to generate at least one second matching degree, where the second matching degree represents a semantic matching degree between the first candidate image and the input text information; and selecting at least one target image matched with the image search requirement from the at least one first candidate image according to the first matching degree and the second matching degree.

The third large model may be a large multimodal model (LMM) used to process visual modality and linguistic modality, and the third large model is a pre-trained large multimodal model. Similar to the second large model, the third large model may be used to perform an image-text analysis task to generate at least one second matching degree according to the input text information and the at least one first candidate image.

Unlike the second large model, an input of linguistic modality of the third large model is a complete input text information, that is, the second large model is used for a local semantic validation, and the third large model is used for a global semantic validation. Compared with the second large model, the input text information processed by the third large model is more complex, so the third large model may adopt LMMs with stronger processing capabilities and larger scales.

The first matching degree and the second matching degree are both for single first candidate object. When selecting the target image, the semantic matching degree between the first candidate image and the image search requirement may be comprehensively evaluated according to the first matching degree and the second matching degree. For example, a weighted summation may be performed on the first matching degree and the second matching degree, the at least one first candidate image may be sorted in descending order according to the weighted summation result, and the first candidate images ranked from first to a predetermined position may be selected as the target images.

After the local semantic validation of the second large model, a relatively accurate local semantic validation result may be obtained between the first candidate image and the input text information. However, large models are prone to hallucinations to generate content that does not match the input text information or does not conform to actual semantics, that is, the information output by the large model may not exist in the first candidate image or the input text information. The hallucination output phenomenon may cause errors in the local semantic validation process, which in turn may cause errors in the final image recall and sorting.

Therefore, in embodiments of the present disclosure, an image-text analysis is performed on the input text information and the at least one first candidate image by using the third large model to generate at least one second matching degree, and it is further determined, from the global semantic perspective, whether the image as a whole meets the image search requirement. Further, the at least one target image selected from the at least one first candidate image according to the first matching degree and the second matching degree may ensure the accuracy of image search from both global semantics and local semantics.

According to embodiments of the present disclosure, for operation S240, the method further includes: selecting at least one second candidate image from the at least one first candidate image according to the first matching degree; performing an image-text analysis on the input text information and the at least one second candidate image by using the third large model to generate at least one third matching degree, where the third matching degree represents a semantic matching degree between the second candidate image and the input text information; and selecting the at least one target image matched with the image search requirement from the at least one second candidate image according to the third matching degree.

After the first matching degree is obtained by the local semantic validation, it is possible to first select at least one second candidate image from the at least one first candidate image based on the first matching degree, and then perform an image-text analysis on the input text information and the at least one second candidate image by using the third large model to generate at least one third matching degree. Similar to the above, the third large model may perform the image-text analysis task to generate the third matching degree.

The third matching degree represents the semantic matching degree between the second candidate image and the input text information, and the second candidate image is an image selected by the local semantic validation. Therefore, at least one target image may be selected from the at least one second candidate image based on the third matching degree directly from the global semantic perspective.

For example, the at least one second candidate image may be sorted in descending order according to the third matching degree, and the top predetermined number of second candidate image may be selected as the target image.

In embodiments of the present disclosure, at least one second candidate image is selected first based on the first matching degree under local semantics, and then an image-text analysis is performed on the input text information and the at least one second candidate image by using the third large model to generate at least one third matching degree, so that the amount of data for subsequent global semantic validation using the third large model may be reduced, and the speed of image search may be improved. Subsequently, the generated third matching degree may be used for selection from the global semantic perspective, which may improve the accuracy of image search in terms of both local semantics and global semantics.

For ease of understanding, two embodiments will be described below by way of example to illustrate the process of selecting at least one target image.

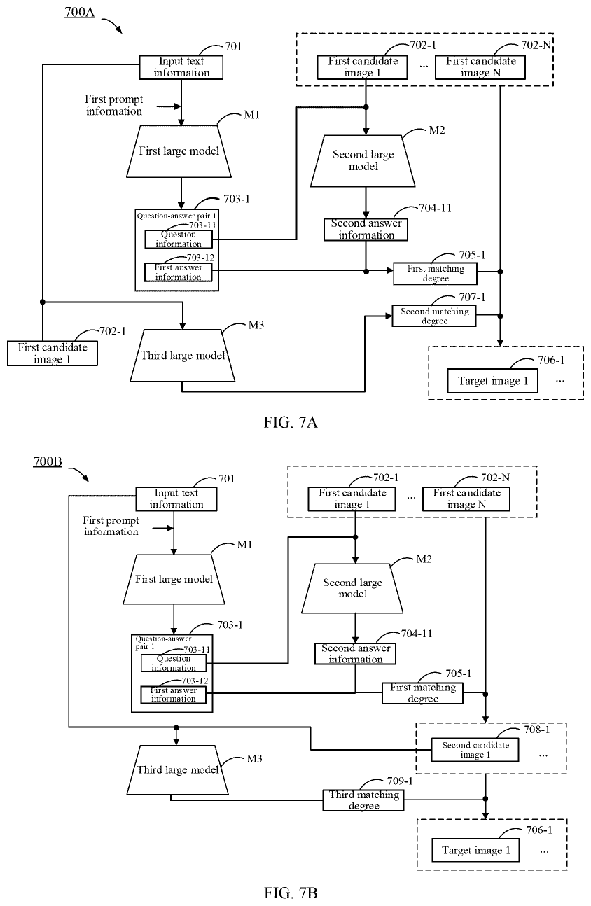

FIG. 7A schematically shows a scenario diagram of determining a target image using the third large model according to an embodiment of the present disclosure. As shown in FIG. 7A, in embodiment 700A, a question-answer pair 1 703-1 is generated based on an input text information 701 and a first prompt information by using the first large model M1. The question-answer pair 1 703-1 includes a question information 703-11 and a first answer information 703-12. For the first candidate image 1 702-1 . . . first candidate image N 702-N matched with the input text information 701, a local semantic analysis is performed on the first candidate image 1 702-1 and the question information 703-11 by using the second large model M2 to generate a second answer information 704-11. A first matching degree 705-1 for the first candidate image 1 702-1 may be determined according to a comparison result between the first answer information 703-12 and the second answer information 704-11.

In addition, a global semantic validation (image-text analysis) is performed on the input text information 701 and the first candidate image 1 702-1 by using the third large model M3 to generate a second matching degree 707-1 for the first candidate image 1 702-1. According to the first matching degree 705-1 and the second matching degree 707-1, it may be determined whether to select a first candidate image 1 from the first candidate image 1 702-1 . . . first candidate image N 702-N as a target image, so as to obtain a target image 1 706-1 . . . .

FIG. 7B schematically shows a scenario diagram of determining a target image using the third large model according to another embodiment of the present disclosure. As shown in FIG. 7B, in embodiment 700B, a process of obtaining the first matching degree 705-1 for the first candidate image 1 702-1 is similar to that of the embodiment 700A, which will not be repeated here. That process is also a local semantic validation process.

After the first matching degree 705-1 is generated, it may be determined, according to the first matching degree 705-1, whether to select the first candidate image 1 from the first candidate image 1 702-1 . . . first candidate image N 702-N as the second candidate image. For example, the at least one second image obtained may be second candidate image 1 708-1 . . . .

In this embodiment, a global semantic validation may be performed on the second candidate image 1 708-1 and the input text information 701 by using the third large model M3 to generate a third matching degree 709 for the second candidate image 1 708-1. According to the third matching degree 709, it may be determined whether to select the second candidate image 1 708-1 from the second candidate image 1 708-1 . . . to obtain at least one target image, such as target image 1 706-1 . . . .

According to embodiments of the present disclosure, the method further includes: acquiring a second prompt information, where the second prompt information is used to prompt the third large model to perform an image-text analysis task; performing the image-text analysis task on the input text information and the at least one first candidate image based on the second prompt information by using the third large model, so as to generate the at least one second matching degree; or performing the image-text analysis task on the input text information and the at least one second candidate image based on the second prompt information by using the third large model, so as to generate the at least one third matching degree.

The third large model may perform the image-text analysis task to generate the second matching degree/third matching degree. In this case, the second prompt information may be used to prompt the third large model to perform the image-text analysis task.

In addition, the form of the generated second matching degree/third matching degree may be prompted in the second prompt information to facilitate selecting and sorting.

For example, the second prompt information may be as follows: “The task is to evaluate and determine whether the given candidate image reflects the text instruction [[INSTRUCTION]]. The steps are as follows: 1. Please carefully observe the provided candidate image. 2. Determine whether it conforms to the description of the text instruction. 3. Please provide the answer in the following form: ANSWER: [Yes/No], where: Select ‘Yes’ if the candidate image correctly conforms to the instruction description. Select ‘No’ if the candidate image does not conform to the instruction description”. In the second prompt information, the placeholder “[INSTRUCTION]” is the position to fill in the input text information, and Yes/No may be converted into numerical values 1/0, respectively, as the second matching degree/third matching degree.

For example, the input text information is as follows: a woman wearing a black shirt is cooking on the stove, with a black dog sitting next to her. The first candidate image/second candidate image is shown as: a woman wearing a black shirt is cooking on the stove, with a black dog and a brown dog sitting next to her. In this case, the third large model outputs ANSWER: [Yes], and the second matching degree/third matching degree is 1.

According to embodiments of the present disclosure, the method further includes: sorting the at least one target image according to a matching degree to form an image search sequence and outputting the image search sequence, where the matching degree includes at least one of the first matching degree, the second matching degree, or the third matching degree.

After at least one target image is selected from the at least one first candidate image, the at least one target image may be output. When outputting, it is possible to sort the at least one target image in descending order of the matching degree to form an image search sequence, and output the image search sequence.

For example, for the embodiments where the target image is selected directly according to the first matching degree, the at least one target image may be sorted in descending order of the first matching degree.

For another example, for the embodiments where the target image is selected according to the first matching degree and the second matching degree, the at least one target image may be sorted in descending order of the first matching degree or the second matching degree, or may be sorted in descending order of a weighted summation result of the first matching degree and the second matching degree.

For another example, for the embodiments where the second candidate image is selected first according to the first matching degree and then the target image is selected from the second candidate image based on the third matching degree, the at least one target image may be sorted in descending order of the first matching degree or the third matching degree, or may be sorted in descending order of a weighted summation result of the first matching degree and the third matching degree.

In this embodiment, the first matching degree reflects the matching degree of local semantics, and the second matching degree/third matching degree reflects the matching degree of global semantics. It is possible to determine a sorting method suitable for the user according to historical behavior data of the user, so as to reduce the time for the user to search for key target images and improve user experience.

In another embodiment, the third large model may not only perform the image-text analysis task to generate the second matching degree/third matching degree, but also give reasons for matching or not while outputting whether the first candidate image/second candidate image is matched with the input text information.

According to embodiments of the present disclosure, the second prompt information is further used to prompt the third large model to perform an interpretation task, and the method further includes: performing the interpretation task on the input text information and the at least one first candidate image based on the second prompt information by using the third large model, so as to generate at least one first interpretation information, where the first interpretation information includes a first interpretation sub-information and/or a second interpretation sub-information, the first interpretation sub-information is used to interpret objects with the same semantics in the input text information and the first candidate image, and the second interpretation sub-information is used to interpret objects with different semantics in the input text information and the first candidate image; or performing the interpretation task on the input text information and the at least one second candidate image based on the second prompt information by using the third large model, so as to generate at least one second interpretation information, where the second interpretation information includes a third interpretation sub-information and/or a fourth interpretation sub-information, the third interpretation sub-information is used to interpret objects with the same semantics in the input text information and the second candidate image, and the fourth interpretation sub-information is used to interpret objects with different semantics in the input text information and the second candidate image.

The second prompt information is added with the interpretation prompt information to prompt the third large model to perform the interpretation task. In this case, the information in the second prompt information used to prompt the third large model to perform the image-text analysis task may be referred to as an image-text analysis prompt information.

For example, the image-text analysis prompt information may be the same as the second prompt information mentioned above. The added interpretation prompt information may be as follows: “After the ANSWER line, briefly interpret how the candidate image conforms or does not conform to the text instruction. Important note: Only analyze based on the text instruction and related images. Ignore elements unrelated to the text instruction. Do not introduce content beyond the text instruction”. In the above-mentioned added interpretation prompt information, “Only analyze based on the text instruction and related images. Ignore elements unrelated to the text instruction. Do not introduce content beyond the text instruction. Always start with the ANSWER line, and then provide the interpretation on a new line.” is used to avoid hallucination output.

For example, the input text information is as follows: a woman wearing a black shirt is cooking on the stove, with a black dog sitting next to her. The first candidate image/second candidate image is shown as: a woman wearing a black shirt is cooking on the stove, with a black dog and a brown dog sitting next to her. In this case, the third large model may output ANSWER: [Yes], the second matching degree/third matching degree is 1, and the image contains a brown dog that is not present in the text, in which “the image contains a brown dog that is not present in the text” is the second interpretation sub-information in the first interpretation information or the fourth interpretation sub-information in the second interpretation information. In another example, the third large model may output: [Yes], the second matching degree/third matching degree is 1, the image contains a brown dog that is not present in the text, and the image contains a black dog that is present in the text”, in which “the image contains a black dog that is present in the text” is the first interpretation sub-information in the first interpretation information or the third interpretation sub-information in the second interpretation information.

In this case, it should be noted that for the prompt information “Only analyze based on the text instruction and related images. Ignore elements unrelated to the text instruction. Do not introduce content beyond the text instruction”, the “brown dog” that is not contained in the input text information is ignored during the image-text analysis, resulting in the answer YES. However, when the interpretation task is performed, an interpretation is provided to facilitate user understanding.

In embodiments of the present disclosure, in the process of local semantic validation and global semantic validation, not only the matched candidate image is returned, but also the first interpretation information/second interpretation information may be generated to analyze the objects and details that are inconsistent between image and text, thereby improving the interpretability and transparency of the image search process and avoiding poor user experience caused by users only receiving similarity value without understanding success/failure of the image search task.

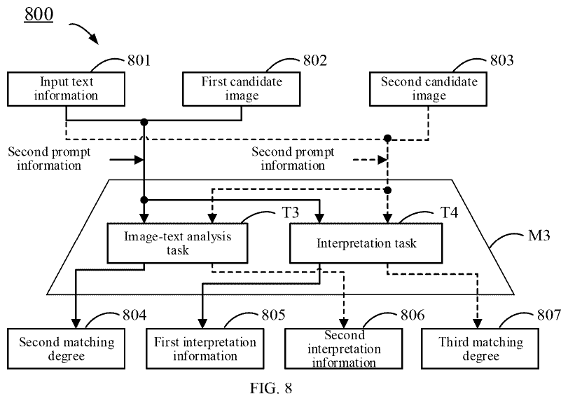

FIG. 8 schematically shows a scenario diagram of the third large model performing an image-text analysis task and an interpretation task according to an embodiment of the present disclosure.

As shown in FIG. 8, a scenario 800 includes two embodiments. In one embodiment, the third large model M3 performs an image-text analysis task T3 and an interpretation task T4 on an input text information 801 and a first candidate image 802 based on the second prompt information, so as to obtain a second matching degree 804 and a first interpretation information 805. The first interpretation information 805 is an interpretation of a difference between the first candidate image 802 and the input text information 801, and each first candidate image corresponds to a first interpretation information. Therefore, after at least one target image is selected according to the first matching degree and the second matching degree 804, the first interpretation information for the target image may be obtained according to a corresponding relationship between the first candidate image and the target image, thereby generating an image search sequence.

In another embodiment, the third large model M3 performs the image-text analysis task T3 and the interpretation task T4 on the input text information 801 and a second candidate image 803 based on the second prompt information, so as to obtain a third matching degree 807 and a second interpretation information 806. Similar to the previous embodiment, after at least one target image is selected according to the third matching degree 807, the second interpretation information for the target image may be obtained according to a corresponding relationship between the second candidate image and the target image, thereby generating an image search sequence.

According to embodiments of the present disclosure, the method further includes: sorting the at least one target image and the first interpretation information according to a matching degree to form an image search sequence and outputting the image search sequence; or sorting the at least one target image and the second interpretation information according to the matching degree to form an image search sequence and outputting the image search sequence.

The matching degree includes at least one of the first matching degree, the second matching degree, or the third matching degree. The method of sorting according to the matching degree is as described above and will not be repeated here.

The image search sequence may be arranged in the form of information pairs. For example, a target image and corresponding first interpretation information/second interpretation information may form an information pair. When outputting the image search sequence, the first interpretation information/second interpretation information may be displayed near the target image.

In embodiments of the present disclosure, the output image search sequence not only includes the retrieved at least one target image but also includes the first interpretation information/second interpretation information for the retrieved target image, which is convenient for users to easily understand the success/failure of the image search task and reasons therefore according to the output image search sequence, thereby providing a good user experience.

According to embodiments of the present disclosure, for operation S210, acquiring at least one first candidate image matched with the input text information includes: determining a text encoding feature of the input text information; and determining the at least one first candidate image according to a similarity between the text encoding feature and an image encoding feature of each image in an image library.

For example, it is possible to encode the input text information in linguistic modality by using a text model to obtain the text encoding feature such as a text vector; and encode the image in visual modality by using an image model to obtain the image encoding feature such as an image vector.

Alternatively, it is also possible to encode the input text information and the image using a large multimodal model to respectively obtain the text encoding feature and the image encoding feature of each image in the image library. For example, a vision-language model (VLM) composed of a visual encoder and a language encoder may be used. The internal language encoder is used to encode the input text information to obtain the text encoding feature, and the internal visual encoder is used to encode the image to obtain the image encoding feature.

The similarity between the text encoding feature and the image encoding feature may be represented by a distance in the vector space. For example, the similarity may be calculated by a distance measurement method such as cosine similarity, Euclidean distance, etc. Then, at least one first candidate image matched with the input text information may be preliminarily selected from the image library according to a predetermined preliminary selection threshold.

In an embodiment, the image encoding feature of each image in the image library may be encoded and stored in advance. During the image search, it is possible to directly acquire the image encoding feature of each image, and calculate the similarity between the image encoding feature and the text encoding feature of the current input text information.

For example, for an input text information T, the text encoding feature of the input text information T may be obtained using a vision-language model VLM, and may be represented using a normalized text vector ν_{T}, ν_{T} ∈ [symbol] ^{d}, where d represents a dimension of the text vector, which is determined by the pre-trained vision-language model VLM. The image encoding features of P images in the image library may be represented by a vector matrix V_{I} composed of normalized image vectors, V_{I} ∈ [symbol] ^{p×d}. Then, a similarity calculation may be performed on the text vector ν_{T} and the image matrix V_{I}, to obtain the similarity between each image and the input text information. The similarity is calculated using Equation (1).

$$s = s i m ( {v}_{T} \cdot {V}_{I} ) = {V}_{I} \cdot {v}_{T} , \qquad ( 1 )$$

where V_{I}·ν_{T} represents inner product, sim( ) represents a similarity function, and an output result s is a vector of length P, s∈ [symbol] ^{P}. Each element in the vector s represents the similarity between the corresponding image and the input text information. The similarities may be sorted in descending order to obtain a list of images matched with the input text information. Then, N images may be selected as the first candidate images, denoted as I₁, . . . , I_{N}.

In embodiments of the present disclosure, at least one first candidate image is preliminarily selected according to the similarity between the text encoding feature of the input text image and the image encoding feature of each image in the image library, thereby ensuring the accuracy of image search while reducing the image processing load of subsequent large models, reducing resource usage, and improving the speed of image search.

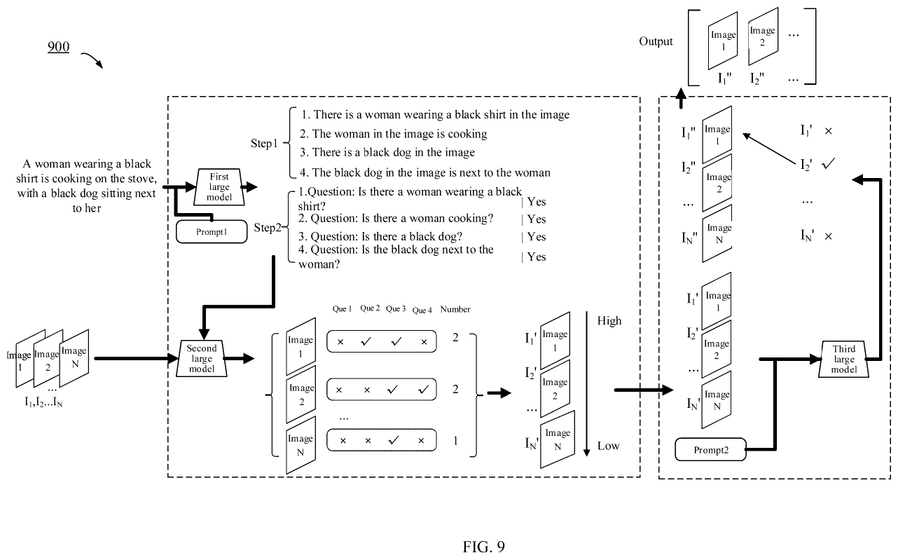

For ease of understanding of the present disclosure, a specific embodiment will be described by way of example to illustrate the process of image search. FIG. 9 schematically shows a scenario diagram of determining the target image according to a specific embodiment of the present disclosure.

In embodiment 900, the input text information T may be “a woman wearing a black shirt is cooking on the stove, with a black dog sitting next to her”, and the pre-selected at least one first candidate image matched with the input text information T includes I₁, I₂, . . . , I_{N}.

A semantic analysis task and a form conversion task may be performed based on Prompt1 (first prompt information) and the input text information T by using a first large model Reasoner. After the semantic analysis task is performed in the first step, M input text sub-information pᵢ may be obtained, represented by a set P={pᵢ}ᵢ₌₁^{M}. For example, four input text sub-information in the form of declarative sentence may be as follows: “1. There is a woman wearing a black shirt in the image. 2. The woman in the image is cooking. 3. There is a black dog in the image. 4. The black dog in the image is next to the woman”. After the form conversion task is performed in the second step, at least one question-answer pair may be obtained as follows: “1. Question: Is there a woman wearing a black shirt? | Yes; 2. Question: Is there a woman cooking? | Yes; 3. Question: Is there a black dog? | Yes; 4. Is there a black dog next to the woman? | Yes;”. The generated M question-answer pairs may include a set of question information Q={qi}ᵢ₌₁^{M} and a set of correct first answer information V={νᵢ}ᵢ₌₁^{M}.

An execution process of the first large model may be expressed by Equation (2).

$$P , Q , V = Reasoner ( T , {Prompt}_{1} ) , \qquad ( 2 )$$

An image-text analysis may be performed on the at least one question information generated by the first large model and the at least one first candidate image I₁, I₂ . . . , I_{N} by using the second large model to generate a second answer information for each question information. Then, it is possible to compare the first answer information and the second answer information for each question information. For example, for image 1 in the first candidate image, the comparison results for questions 1˜4 are as follows: different, identical, identical, different, and the number of question information with comparison result of identical is 2; for image 2 in the first candidate image, the comparison results for questions 1˜4 are as follows: different, different, identical, identical, and the number of question information with comparison result of identical is 2 . . . for image N, the comparison results for questions 1˜4 are as follows: different, different, identical, different, and the number of question information with comparison result of identical is 1. In this embodiment, the comparison results of different and identical are represented by “X” and “✓”, respectively.

The process of determining the second candidate image from the first candidate image may be expressed by Equation (3) to Equation (5).

$${p}_{j} = Verifier ( {I}_{i} , {q}_{j} ) , for j = i , … , M , \qquad ( 3 )$$

$${c}_{i} = {\sum }_{j = 1}^{M} 𝕀 ( {p}_{j} = {v}_{j} ) , \qquad ( 4 )$$

$${I}_{1}^{′} , … {I}_{N}^{′} = {argsort}_{↓} ( c ) \qquad ( 5 )$$

where an image-text analysis is performed on a first candidate image Iᵢ and a question information qⱼ by using a second large model Verifier to obtain a second answer information pⱼ. It is determined, by an indicator function I(·), whether the second answer information pⱼ and the first answer information νⱼ for a same question information j are identical. If yes, a value of 1 is assigned, otherwise a value of 0 is assigned. For each candidate image I, the number of question information for which the first answer information and the second answer information are identical under M question information may be synthesized to obtain a first matching degree cᵢ. c={c₁, c₂, . . . , c_{N}} represents a vector of the first matching degree, c∈ [symbol] ^{N}·argsortᵢ(·) represents sorting in descending order according to the value of C, and I′₁, . . . I′_{N} represents at least one second candidate image I′₁, I′₂, . . . , I_{N}′ obtained after the local semantic validation.

An image-text analysis is performed on the at least one second candidate image I′₁, I′₂, . . . , I_{N}′ and the input text information T based on Prompt2 (second prompt information) by using a third large model Evaluator to generate a third matching degree for each second candidate image, so as to evaluate the matching degree between each second candidate image and the input text information in global semantics. As shown in FIG. 9, the third matching degrees for the second candidate images I′₁, I′₂, . . . , I_{N}′ are 0, 1 . . . 1, respectively, shown as a sequence of “X” and “✓” next to I′₁, I′₂, . . . , I_{N}′.

As shown in FIG. 9, according to the third matching degree, the ranking of image 2 may be adjusted forward to obtain at least one target image I″₁, I″₂, . . . , I″_{N}, and the image search sequence is fed back to the user as an output.

The process of determining the target image from the second candidate image may be expressed by Equation (6) to Equation (8).

$${f}_{i} = Evaluator ( {I}_{i}^{′} , T , {Prompt}_{2} ) , i = 1 , 2 , … , N , \qquad ( 6 )$$

$$f = \{ {f}_{1} , {f}_{2} , … , {f}_{N} \} , \qquad ( 7 )$$

$${I}_{1}^{″} , {I}_{2}^{″} , … , {I}_{N}^{″} = {argsort}_{↓} ( f ) , \qquad ( 8 )$$

where fᵢ represents a third matching degree obtained after the third large model Evaluator performs a global semantic validation on the second candidate image I′ᵢ and the input text information T, with a value of 1 (indicating matched) or 0 (indicating not matched). f∈ [symbol] ^{d} represents vectors of the third matching degrees for all second candidate images, composed of 0 or 1. I″₁, I″₂ . . . , I″_{N} represents a result of reordering the second candidate images after the third matching degrees are obtained by global semantic validation. argsortᵢ(·) has the same meaning as the explanation portion for Equation (3) to Equation (5).

In addition, the third large model Evaluator may further generate an interpretation information based on Prompt2 and output the interpretation information.

Embodiments of the present disclosure may be implemented to perform multi-level semantic validation on images at a local semantic level and a global semantic levels. The local semantic validation ensures that the retrieved image meets the image search requirement in specific details, such as object color, shape, and background. The global semantic validation may confirm the overall semantic relationship, ensuring that the retrieved target image is not only similar to the input text information in terms of features but also highly consistent with the input text information in terms of complex semantic relationship (such as spatial relationship between objects), thereby effectively improving the matching accuracy of complex semantic relationship and details, making the returned target image more aligned with the image search requirement, and improving the accuracy of image search. In addition, the output image search sequence includes the target image and the interpretation information, which facilitates users' understanding in the success/failure of the image search task and reasons thereof, thereby providing a good user experience.

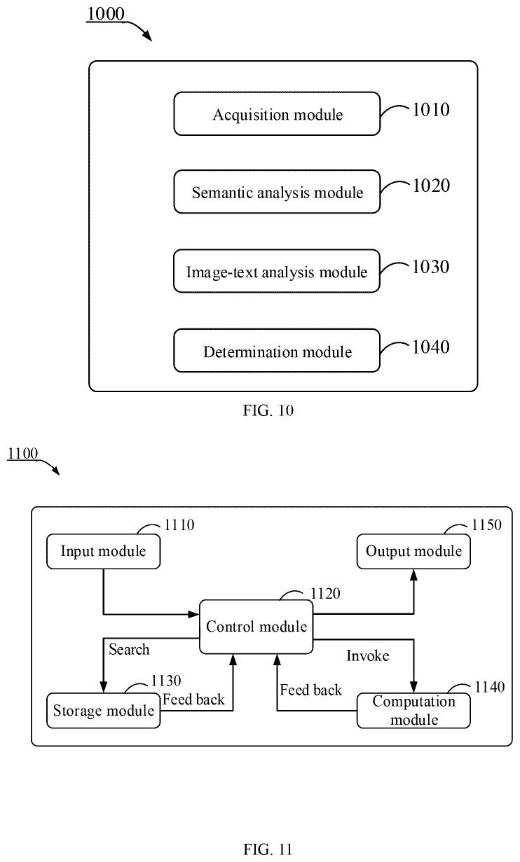

FIG. 10 schematically shows a block diagram of an image search apparatus according to a specific embodiment of the present disclosure.

As shown in FIG. 10, an image search apparatus 1000 includes an acquisition module 1010, a semantic analysis module 1020, an image-text analysis module 1030, and a determination module 1040.

The acquisition module 1010 is used to acquire at least one first candidate image matched with an input text information entered by a user, where the input text information represents an image search requirement of the user.

The semantic analysis module 1020 is used to perform a semantic analysis on the input text information by using a first large model to generate at least one question-answer pair, where the question-answer pair includes a question information extracted from the input text information and a first answer information extracted from the input text information.

The image-text analysis module 1030 is used to perform an image-text analysis on the at least one question information and the at least one first candidate image by using a second large model to generate a second answer information for answering each question information.

The determination module 1040 is used to determine at least one target image matched with the image search requirement from the at least one first candidate image according to a comparison result between the at least one first answer information and the at least one second answer information.

According to embodiments of the present disclosure, the semantic analysis module 1020 includes a first acquisition sub-module, a semantic analysis sub-module, and a form conversion sub-module.

The first acquisition sub-module is used to acquire a first prompt information, where the first prompt information is used to prompt the first large model to perform a semantic analysis task and a form conversion task.

The semantic analysis sub-module is used to perform the semantic analysis task based on the first prompt information and the input text information by using the first large model, so as to extract at least one input text sub-information from the input text information.

The form conversion sub-module is used to perform the form conversion task on each input text sub-information based on the first prompt information by using the first large model, so as to convert the input text sub-information into the question-answer pair.

According to embodiments of the present disclosure, the semantic analysis sub-module includes: a first semantic analysis unit used to perform the semantic analysis task based on the first prompt information and the input text information by using the first large model, so as to extract at least one input text sub-information from the input text information based on a plurality of semantic dimensions, where the semantic dimension includes at least one of a color, a shape, or a background.

According to embodiments of the present disclosure, the acquisition sub-module includes: a first combining unit used to combine a semantic splitting example and a form conversion example to obtain the first prompt information.

According to embodiments of the present disclosure, the acquisition sub-module includes a first example determination unit and a second combining unit.

The first example determination unit is used to determine, according to a scene type of the input text information, a semantic splitting example matched with the scene type and a form conversion example matched with the scene type.

The second combining unit is used to combine the semantic splitting example matched with the scene type and the form conversion example matched with the scene type to obtain the first prompt information.

According to embodiments of the present disclosure, the acquisition sub-module includes a second example determination unit and a third combining unit.

The second example determination unit is used to determine at least one semantic splitting example and at least one form conversion example according to a text complexity of the input text information.

The third combining unit is used to combine the at least one semantic splitting example and the at least one form conversion example to obtain the first prompt information.

According to embodiments of the present disclosure, the determination module 1040 includes a first determination sub-module, a second determination sub-module, and a first selection sub-module.

The first determination sub-module is used to determine, for each first candidate image, a comparison result between the first answer information and the second answer information for answering a same question information.

The second determination sub-module is used to determine a first matching degree between each first candidate image and the input text information according to the comparison result.

The first selection sub-module is used to select the at least one target image matched with the image search requirement from the at least one first candidate image according to the first matching degree.

According to embodiments of the present disclosure, the determination module 1040 further includes a first image-text analysis sub-module and a second selection sub-module.

The first image-text analysis sub-module is used to perform an image-text analysis on the input text information and the at least one first candidate image by using a third large model to generate at least one second matching degree, where the second matching degree represents whether the first candidate image is matched with the input text information in terms of semantics.

The second selection sub-module is used to select the at least one target image matched with the image search requirement from the at least one first candidate image according to the first matching degree and the second matching degree.

According to embodiments of the present disclosure, the determination module 1040 further includes a third selection sub-module, a second image-text analysis sub-module, and a fourth selection sub-module.

The third selection sub-module is used to select at least one second candidate image from the at least one first candidate image according to the first matching degree.

The second image-text analysis sub-module is used to perform an image-text analysis on the input text information and the at least one second candidate image by using a third large model to generate at least one third matching degree, where the third matching degree represents whether the second candidate image is matched with the input text information in terms of semantics.

The fourth selection sub-module is used to select the at least one target image matched with the image search requirement from the at least one second candidate image according to the third matching degree.

According to embodiments of the present disclosure, the determination module 1040 further includes a second acquisition sub-module and a third image-text analysis sub-module.

The second acquisition sub-module is used to acquire a second prompt information, where the second prompt information is used to prompt the third large model to perform an image-text analysis task.

The third image-text analysis sub-module is used to perform the image-text analysis task on the input text information and the at least one first candidate image based on the second prompt information by using the third large model, so as to generate the at least one second matching degree; or perform the image-text analysis task on the input text information and the at least one second candidate image based on the second prompt information by using the third large model, so as to generate the at least one third matching degree.

According to embodiments of the present disclosure, the image search apparatus 1000 further includes: a first output module used to sort the at least one target image according to a matching degree to form an image search sequence and return the image search sequence to the user, where the matching degree includes at least one of the first matching degree, the second matching degree, or the third matching degree.

According to embodiments of the present disclosure, the second prompt information is further used to prompt the third large model to perform an interpretation task, and the determination module 1040 further includes a first interpretation sub-module or a second interpretation sub-module.

The first interpretation sub-module is used to perform the interpretation task on the input text information and the at least one first candidate image based on the second prompt information by using the third large model, so as to generate at least one first interpretation information used to interpret objects with the same/different semantics in the input text information and the first candidate image.

The second interpretation sub-module is used to perform the interpretation task on the input text information and the at least one second candidate image based on the second prompt information by using the third large model, so as to generate at least one second interpretation information used to interpret objects with the same/different semantics in the input text information and the second candidate image.

According to embodiments of the present disclosure, the image search apparatus 1000 further includes a second output module or a third output module.

The second output module is used to sort the at least one target image and the first interpretation information according to a matching degree to form an image search sequence and return the image search sequence to the user.

The third output module is used to sort the at least one target image and the second interpretation information according to the matching degree to form an image search sequence and return the image search sequence to the user.

According to embodiments of the present disclosure, the acquisition module 1010 further includes a feature determination sub-module and an image determination sub-module.

The feature determination sub-module is used to determine a text encoding feature of the input text information.

The image determination sub-module is used to determine the at least one first candidate image according to a similarity between the text encoding feature and an image encoding feature of each image in an image library.

FIG. 11 schematically shows a structural block diagram of an intelligent agent of artificial intelligence according to embodiments of the present disclosure. In embodiments of the present disclosure, inspired by the von Neumann architecture in modern computer theory, as shown in FIG. 11, an AI agent 1100 may include five core modules, namely an input module 1110, a control module 1120, a storage module 1130, a computation module 1140, and an output module 1150.

The input module 1110 is used to receive or sense information such as queries, requests, instructions, signals or data from the outside world (e.g., users or external environments) and convert the information into a format that the AI agent 1100 may understand and process. The input module 1110 is a primary link for the AI agent 1100 to interact with the outside world, enabling the AI agent 1100 to efficiently and accurately acquire necessary “sensory” information and make a response to the information.

In an example, the input module 1110 may receive the input text information mentioned above.

In an example, the control module 1120 is a core support for the AI agent 1100's ability to handle complex tasks. The control module 1120 may perform the image search method described above.

In an example, during operation, the control module 1120 may continuously interact with the storage module 1130, the computation module 1140 and/or the output module 1150. However, it should be noted that in embodiments of the present disclosure, the control module 1120 acts as a sole initiator to initiate communication with the storage module 1130, the computation module 1140 and/or the output module 1150, while no communication coupling is provided between the storage module 1130, the computation module 1140 and the output module 1150.

In an example, the performance of the control module 1120 may be closely related to the large model on which the AI agent 1100 is based. In order to fully leverage the capabilities of the large model, an internal structure of the control module 1120 may be designed to be highly configurable and scalable, so as to handle various types of tasks and requirements in real-world scenarios, such as the semantic analysis task, the form conversion task, the image-text analysis task and the interpretation task mentioned above.

The storage module 1130 may be used to remember information such as historical dialogues and event streams. The prompt information, various input text sub-information and the question-answer pairs mentioned above may be included in the storage module 1130.

The computation module 1140 may be regarded as a predefined tool library. Controls used for text encoding and image encoding mentioned above may be included in the computation module 1140.

In an example, the output module 1150 may output the at least one target image mentioned above.

The AI agent 1100 according to embodiments of the present disclosure may simply and effectively enhance the level of intelligence and improve flexibility and versatility.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor. The memory stores instructions executable by the at least one processor, and the instructions are used to, when executed by the at least one processor, cause the at least one processor to implement the method described above.

According to embodiments of the present disclosure, a non-transitory computer-readable storage medium having computer instructions therein is provided, and the computer instructions are used to cause a computer to implement the methods described above.

According to embodiments of the present disclosure, a computer program product containing a computer program is provided, and the computer program is used to, when executed by a processor, cause the processor to implement the method described above

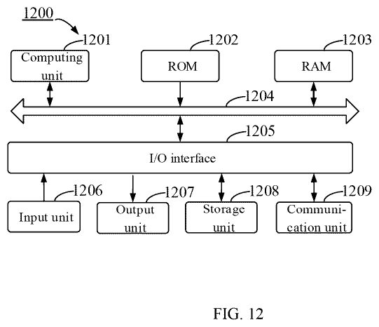

FIG. 12 schematically shows a block diagram of an electronic device 1200 suitable for implementing the image search method according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 12, the electronic device 1200 includes a computing unit 1201 which may perform various appropriate actions and processes according to a computer program stored in a read only memory (ROM) 1202 or a computer program loaded from a storage unit 1208 into a random access memory (RAM) 1203. In the RAM 1203, various programs and data necessary for an operation of the electronic device 1200 may also be stored. The computing unit 1201, the ROM 1202 and the RAM 1203 are connected to each other through a bus 1204. An input/output (I/O) interface 1205 is also connected to the bus 1204.

A plurality of components in the electronic device 1200 are connected to the I/O interface 1205, including: an input unit 1206, such as a keyboard, or a mouse; an output unit 1207, such as displays or speakers of various types; a storage unit 1208, such as a disk, or an optical disc; and a communication unit 1209, such as a network card, a modem, or a wireless communication transceiver. The communication unit 1209 allows the electronic device 1200 to exchange information/data with other devices through a computer network such as Internet and/or various telecommunication networks.

The computing unit 1201 may be various general-purpose and/or dedicated processing assemblies having processing and computing capabilities. Some examples of the computing units 1201 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1201 executes various methods and processes described above, such as the image search method. For example, in some embodiments, the image search method may be implemented as a computer software program which is tangibly embodied in a machine-readable medium, such as the storage unit 1208. In some embodiments, the computer program may be partially or entirely loaded and/or installed in the electronic device 1200 via the ROM 1202 and/or the communication unit 1209. The computer program, when loaded in the RAM 1203 and executed by the computing unit 1201, may execute one or more steps in the image search method described above. Alternatively, in other embodiments, the computing unit 1201 may be used to perform the image search method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the image search method of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. An image search method, comprising:
acquiring at least one first candidate image matched with an input text information, wherein the input text information represents an image search requirement;
performing a semantic analysis on the input text information by using a first large model to generate at least one question-answer pair, wherein the question-answer pair comprises a question information extracted from the input text information and a first answer information extracted from the input text information;
performing an image-text analysis on the at least one question information and the at least one first candidate image by using a second large model to generate a second answer information for answering each question information; and
determining at least one target image matched with the image search requirement from the at least one first candidate image according to a comparison result between the at least one first answer information and the at least one second answer information.

2. The method according to claim 1, wherein the performing a semantic analysis on the input text information by using a first large model to generate at least one question-answer pair comprises:
acquiring a first prompt information, wherein the first prompt information is configured to prompt the first large model to perform a semantic analysis task and a form conversion task;
performing the semantic analysis task based on the first prompt information and the input text information by using the first large model, so as to extract at least one input text sub-information from the input text information; and
performing the form conversion task on each input text sub-information based on the first prompt information by using the first large model, so as to convert the input text sub-information into the question-answer pair.

3. The method according to claim 2, wherein the performing the semantic analysis task based on the first prompt information and the input text information by using the first large model so as to extract at least one input text sub-information from the input text information comprises:
performing the semantic analysis task based on the first prompt information and the input text information by using the first large model, so as to extract at least one input text sub-information from the input text information based on a plurality of semantic dimensions, wherein the semantic dimension comprises at least one of a color, a shape, or a background.

4. The method according to claim 2, wherein the acquiring a first prompt information comprises:
combining a semantic splitting example and a form conversion example to obtain the first prompt information.

5. The method according to claim 2, wherein the acquiring a first prompt information comprises:
determining, according to a scene type of the input text information, a semantic splitting example matched with the scene type and a form conversion example matched with the scene type; and
combining the semantic splitting example matched with the scene type and the form conversion example matched with the scene type to obtain the first prompt information.

6. The method according to claim 3, wherein the acquiring a first prompt information comprises:
determining, according to a scene type of the input text information, a semantic splitting example matched with the scene type and a form conversion example matched with the scene type; and
combining the semantic splitting example matched with the scene type and the form conversion example matched with the scene type to obtain the first prompt information.

7. The method according to claim 4, wherein the acquiring a first prompt information comprises:
determining, according to a scene type of the input text information, a semantic splitting example matched with the scene type and a form conversion example matched with the scene type; and
combining the semantic splitting example matched with the scene type and the form conversion example matched with the scene type to obtain the first prompt information.

8. The method according to claim 2, wherein the acquiring a first prompt information comprises:
determining at least one semantic splitting example and at least one form conversion example according to a text complexity of the input text information; and
combining the at least one semantic splitting example and the at least one form conversion example to obtain the first prompt information.

9. The method according to claim 1, wherein the determining at least one target image matched with the image search requirement from the at least one first candidate image according to a comparison result between the at least one first answer information and the at least one second answer information comprises:
determining, for each first candidate image, a comparison result between the first answer information and the second answer information for answering a same question information;
determining a first matching degree between each first candidate image and the input text information according to the comparison result; and
selecting the at least one target image matched with the image search requirement from the at least one first candidate image according to the first matching degree.

10. The method according to claim 9, further comprising:
performing an image-text analysis on the input text information and the at least one first candidate image by using a third large model to generate at least one second matching degree, wherein the second matching degree represents a semantic matching degree between the first candidate image and the input text information; and
selecting the at least one target image matched with the image search requirement from the at least one first candidate image according to the first matching degree and the second matching degree.

11. The method according to claim 9, further comprising:
selecting at least one second candidate image from the at least one first candidate image according to the first matching degree;
performing an image-text analysis on the input text information and the at least one second candidate image by using a third large model to generate at least one third matching degree, wherein the third matching degree represents a semantic matching degree between the second candidate image and the input text information; and
selecting the at least one target image matched with the image search requirement from the at least one second candidate image according to the third matching degree.

12. The method according to claim 10, further comprising:
acquiring a second prompt information, wherein the second prompt information is configured to prompt the third large model to perform an image-text analysis task;
performing the image-text analysis task on the input text information and the at least one first candidate image based on the second prompt information by using the third large model, so as to generate the at least one second matching degree; or performing the image-text analysis task on the input text information and the at least one second candidate image based on the second prompt information by using the third large model, so as to generate the at least one third matching degree.

13. The method according to claim 11, further comprising:
acquiring a second prompt information, wherein the second prompt information is configured to prompt the third large model to perform an image-text analysis task;
performing the image-text analysis task on the input text information and the at least one first candidate image based on the second prompt information by using the third large model, so as to generate the at least one second matching degree; or performing the image-text analysis task on the input text information and the at least one second candidate image based on the second prompt information by using the third large model, so as to generate the at least one third matching degree.

14. The method according to claim 9, further comprising:
sorting the at least one target image according to a matching degree to form an image search sequence and outputting the image search sequence, wherein the matching degree comprises at least one of the first matching degree, the second matching degree, or the third matching degree.

15. The method according to claim 12, wherein the second prompt information is further configured to prompt the third large model to perform an interpretation task, and the method further comprises:
performing the interpretation task on the input text information and the at least one first candidate image based on the second prompt information by using the third large model, so as to generate at least one first interpretation information, wherein the first interpretation information comprises a first interpretation sub-information and/or a second interpretation sub-information, the first interpretation sub-information is configured to interpret objects with the same semantics in the input text information and the first candidate image, and the second interpretation sub-information is configured to interpret objects with different semantics in the input text information and the first candidate image; or
performing the interpretation task on the input text information and the at least one second candidate image based on the second prompt information by using the third large model, so as to generate at least one second interpretation information, wherein the second interpretation information comprises a third interpretation sub-information and/or a fourth interpretation sub-information, the third interpretation sub-information is configured to interpret objects with the same semantics in the input text information and the second candidate image, and the fourth interpretation sub-information is configured to interpret objects with different semantics in the input text information and the second candidate image.

16. The method according to claim 15, further comprising:
sorting the at least one target image and the first interpretation information according to a matching degree to form an image search sequence and outputting the image search sequence; or
sorting the at least one target image and the second interpretation information according to the matching degree to form an image search sequence and outputting the image search sequence.

17. The method according to claim 1, wherein the acquiring at least one first candidate image matched with an input text information comprises:
determining a text encoding feature of the input text information; and
determining the at least one first candidate image according to a similarity between the text encoding feature and an image encoding feature of each image in an image library.

18. An intelligent agent, configured to perform the method of claim 1.

19. An electronic device, comprising:
at least one processor; and
a memory communicatively connected to the at least one processor, wherein the memory stores instructions executable by the at least one processor, and the instructions are configured to, when executed by the at least one processor, cause the at least one processor to implement the method of claim 1.

20. A non-transitory computer-readable storage medium having computer instructions therein, wherein the computer instructions are configured to cause a computer to implement the method of claim 1.
